(19) United States
(12) Patent Application Publication
(10) Pub. No.: US 2008/0163054 A1
(43) Pub. Date: Jul. 3, 2008

(54) TOOLS FOR PRODUCT DEVELOPMENT COMPRISING COLLECTIONS OF AVATARS AND VIRTUAL REALITY BUSINESS MODELS FOR AVATAR USE

(76) Inventors: Christopher M. Pieper, Hortonville, WI (US); Mark D. Perkins, Appleton, WI (US); Jeffrey P. Drake, Neenah, WI (US); Daniel P. Gara, Appleton, WI (US); Suzanne K. Sullivan, Combined Locks, WI (US); John E. Kerins, Neenah, WI (US); William M. Lynch, Greenville, WI (US)

Correspondence Address: PATTERSON & SHERIDAN, L.L.P.;ATTN: GERO G. MCCLELLAN / KIMBERLY-CLARK, 3040 POST OAK BLVD., SUITE 1500, HOUSTON, TX, 77056, US

(21) Appl. No.: 11/618,767

(22) Filed: Dec. 30, 2006

(51) Int. Cl. G06F 3/048

(52) U.S. Cl. 715/706

(57) ABSTRACT

Virtual reality tools for product development including collections of avatars and virtual reality business models for avatar use. A method of designing a product to be worn by an individual includes selecting a population of avatars, where each avatar provides a representation of at least a portion a human body, and the population of avatars may be representative of a population of individuals. The method also includes obtaining a set of data describing a product to be worn by the individuals in the population of individuals, for each avatar, in the population avatars, generating a virtual reality simulation that simulates an avatar interacting with the product, and analyzing the interaction between the avatar and the selected product to evaluate at least one performance characteristic of the product.

### CROSS-REFERENCE TO RELATED APPLICATIONS

This application is related to U.S. patent application Ser. No. 11/618,764, titled: “Virtual Reality System Including Personalized Virtual Environments,” and having attorney docket No. KIMB/0008 filed on Dec. 31, 2006, and incorporated by reference herein in its entirety.

### BACKGROUND OF THE INVENTION

1. Field of the Invention

Embodiments of the present invention generally relate to virtual reality simulations, and more particularly to virtual reality tools for product development comprising collections of avatars and to virtual reality business models for avatar use.

2. Description of the Related Art

Clothing and other articles which are used on the body should fit so as to be comfortable when an individual is stationary, such as when standing or sitting, and also during movement, such as when walking. One ideal article would fit against the individual's body with suitable contact pressure sufficient to hold the article in place but without constricting the skin or degrading comfort. This is challenging because of the wide variation in individual body shapes and sizes as well as the wide variety of material properties an article of clothing may have.

Further, whether an individual deems an article of clothing to “fit” may depend on both an initial position of the article relative to the body and any subsequent movements which shift relative positions, deflect the article's shape, and/or cause the article to apply greater or lesser pressure against portions of the wearer's body. Comfort is influenced by multiple factors including the shape of the user's body, mechanical properties of the underlying bodily tissue (e.g., some portions of the body are more sensitive then others), the shape and size of the article, mechanical properties of the article, and interactions between the article and any other adjacent articles. These properties are highly three-dimensional in nature and are not easily analyzed when designing a new article or improving an existing article's configuration.

In addition to comfort, articles may have functional requirements which aggravate the difficulty of finding a satisfactory configuration. For example, absorbent products for personal care and/or personal protective use, such as disposable diapers, disposable pants, medical garments, feminine hygiene products, incontinence products, medical drapes, facemasks and barrier products, should fit well against the body not only for comfort, but also for effectiveness in absorbing bodily excretions or exudates without leakage. A product of this type that fails to fit well may apply undesired pressure against the user's body or contain gaps or openings that can cause the product to fail functionally. For example, as a person stands up from a seated position or walks, his or her thighs may squeeze a diaper or other absorbent product and may deform it in a manner that results in leakage of fluid. Similarly, personal care products used in spas such as moisturizing gloves or socks may leak or perform poorly if not well designed. Such products perform well when the product holds a fluid or gel inside the product, without being overly constrictive for the wearer.

Thus, developing new or improved products that avoid these problems is complex due to the large number of potential shapes, contours, sizes, component materials, and material distributions. At the same time, the advent of new materials with an improved range of compressive and elastic properties and less bulk emphasizes a need to understand the complex interactions between the body and the product. Unfortunately, the process of identifying an acceptable or optimal combination of design parameters that is both is functionally effective and is comfortable across a normal range of user body shapes and motions is time consuming and can become a substantial expense.

Moreover, even when a relatively optimal product configuration is identified, such a configuration may not scale up (or down) well for individuals of different sizes, and the process may need to be repeated for different sizes of the product or to configure the same product when targeted to different population groups. This reality is compounded by the broad variety of population groups and of products that are available. Nevertheless, from the perspective of a product manufacturer, one goal of product design is to tailor the number of different product configurations that are required for a given product, or more simply, to offer as small a number of different product sizes (or configurations) as possible that is also effective for a large percentage of a target population. For example, a disposable diaper design may be designed to be effective for a large percentage of infants of a given age and weight. Testing such a design, however, can be very difficult. First, obviously, infants are unable to provide much feedback regarding the qualitative experience wearing a given design. Moreover, the rate of infant growth often exceeds the ability for a product manufacturer to test multiple designs using a single group of test subjects, making it very difficult to effectively test multiple product configurations.

Similarly, from a consumer's perspective, it is often difficult to determine the appropriate size for an article of clothing, or to determine in advance, whether a personal care product will function effectively, given the particular body size, shape, etc., of the consumer. Often consumers simply engage in an ad hoc process of trial and error. For example, a mother may test different diaper products for an infant until one is found that seems to function well. Of course, as the infant grows, the ad hoc trial and error approach needs to be repeated, making such an approach effective only marginally, and only for limited periods of time.

In some cases, manufacturers and marketers of consumer products, as well as consumers, have turned to the use of virtual reality tools to assist in product design, evaluation, and selection. For example, virtual reality tools are available to simulate an article being worn on the body of an individual or to simulate the performance of a personal care product. Such systems typically create a computer generated image of a person “wearing” a given product. Similarly, virtual reality tools are available to simulate consumer activity and are used to conduct market research based on consumer interaction with a virtual environment or virtual product. For example, consumers may be presented with a set of design choices for a product related to size, shape, color, etc., and the choices are used to help drive the design process.

However, these simulations typically provide only a visual image of the product being worn by the individual, and do not address whether a given product will fit or perform as desired. Further, while virtual reality tools are available to simulate the wearing and use of a given product on a given individual, current techniques lack the flexibility to design or evaluate product suitability or performance for a population of individuals. For example, simulations of an article of clothing “fit” or performance characteristics based on a virtual reality simulation of one individual interacting with the article may not generalize well to populations of individuals having a range of sizes, shapes, etc. Similarly, virtual reality simulations that simply “paint” an image of an article of clothing onto a representation of a consumer fail to assist consumers in making decisions regarding how well a particular article may fit or how well a given either the shape and size of the individual or the article, or given the different selections of product size.

As the foregoing illustrates, there is a continuing need for improved techniques for designing and evaluating articles of clothing and a variety of personal care products worn on or around the body, for both comfort and functionality. Similarly, there remains a need for techniques for a retailer to assist individual consumers with product sizing and selection, both for the “fit” of a particular article as well as for the selecting products that will have a desired performance characteristic.

### SUMMARY OF THE INVENTION

One embodiment of the invention includes a computer-assisted method of designing a product to be worn by an individual. The method generally includes selecting a population of avatars. Each avatar provides a representation of at least a portion of a human body and the population of avatars is representative of a population of individuals. The method also includes obtaining a set of data describing a product to be worn by the individuals in the population of individuals. For each avatar in the population of avatars, the method also includes, generating a virtual reality simulation that simulates an avatar interacting with the product, and analyzing the interaction between the avatar and the selected product to evaluate at least one performance characteristic of the product.

Another embodiment of the invention includes a computer-readable storage medium containing a program configured to generate a virtual reality simulation used to facilitate market research. The program may include instructions for performing operations, including: receiving a selection of a population of avatars. Each avatar provides a representation of at least a portion of a body and the population of avatars is representative of a population of individuals. The operations may further include obtaining a set of data describing a product to be worn by the individuals in the population of individuals. For each avatar in the population of avatars, the operations also include, generating a virtual reality simulation that simulates an avatar interacting with the product, and analyzing the interaction between the avatar and the selected product to evaluate at least one performance characteristic of the product.

Another embodiment of the invention includes a computer-implemented method for assisting a consumer purchasing decision. The method generally includes obtaining a first set of data describing at least one physical characteristic of an individual and generating a computer-based avatar. The avatar provides a representation of at least a portion the body of the individual. The method also includes obtaining a set of data describing a product to be worn by the individual, generating a virtual reality simulation that simulates the avatar interacting with the product, and analyzing the interaction between the avatar and the selected product to evaluate at least one performance characteristic of the product. The results of the virtual reality simulation may be presented to the individual.

Still another embodiment of the invention includes a computer-readable storage medium containing a program configured to generate a virtual reality simulation for assisting a consumer purchasing decision. The program generally includes instructions for performing operations of receiving a first set of data describing at least one physical characteristic of an individual, generating a computer-based avatar, where the avatar provides a representation of at least a portion the body of the individual, and obtaining a set of data describing a product to be worn by the individual. The operations may further include instructions for generating the virtual reality simulation that simulates the avatar interacting with the product, analyzing the interaction between the avatar and the selected product to evaluate at least one performance characteristic of the product, and presenting the individual with the results of the virtual reality simulation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram of a computing environment and virtual reality system, according to one embodiment of the invention.

FIG. 2 is a conceptual diagram further illustrating components of the virtual reality system first shown in FIG. 1, according to one embodiment of the invention.

FIG. 3 is a flow diagram illustrating a method for generating a virtual reality simulation for a population of avatars, according to one embodiment of the invention.

FIG. 4 is a flow diagram illustrating a method for assisting a consumer purchasing decision using virtual reality simulation that includes an avatar representation of the individual, according to one embodiment of the invention.

### DETAILED DESCRIPTION

Embodiments of the invention provide virtual reality tools used for product development comprising collections of avatars and business models for using virtual reality avatars within a virtual reality simulation. Using a collection of avatars can greatly reduce both product design costs and time-to-market cycles, as well as improve profitability. Further, virtual reality avatars may be used to assist consumers with product sizing and selection, decisions. Embodiments of the invention may allow a product manufacturer to optimize a selection of configurations and sizes for a given product for a given target population

As is known, a variety of computational tools are available to create virtual reality simulations. For example, U.S. Pat. No. 6,810,300 “Method of Designing a Product Worn on a Body in a Virtual Environment” issued to Woltman, et al. on Oct. 26, 2004, and incorporated by reference herein in its entirety, describes a computer-based virtual product development and testing system. As disclosed in the '300 patent, a virtual wearer sub-model is created to represent the body of an individual and a virtual product sub-model is created for use on the body. An interaction model defines a set of interactions to simulate between the virtual product worn by the virtual wearer sub-model and the virtual product sub-model. A product-use model may be used to determine the forces, deformations, and stresses caused by simulated movement and interaction between the virtual wearer sub-model and the virtual product sub-model using any suitable numerical method analysis technique.

Typically, the analysis may be used to evaluate the performance of at least one product feature of the product and/or wearer body. For example, aspects of “fit” such as contact pressure distribution, total body volume with, and without the product, as well as other metrics may be used. The product sub-model may be modified in response to the performance of the product feature in the virtual reality simulation, and the simulation may be performed repeatedly in order to improve the design of the product. Similarly, the performance of the virtual product may be evaluated using the techniques described in U.S. Pat. No. 7,099,734 “Method of Evaluating the Performance of a Product Using a Virtual Environment,” issued to Pieper, et al. on Aug. 29, 2004, and incorporated by reference herein in its entirety.

In one embodiment, a virtual reality simulation may be used to design and evaluate the performance of a product for a population of avatars. Individually, each avatar provides a virtual representation of an individual human body, or part of a body. The population of avatars may represent actual individuals or may be generated to represent individuals having a particular population profile, or both. For example, a profile may be used to describe a target population based on an expected distribution of height, size, weights, shape, and other quantitative measurements. Thus, the population of avatars may be defined so as to be representative of a population of real persons, and a population of avatars may be created to represent a class of infants, children, or adults, of any ethnographic or demographic population cohort. The population of avatars may be used to test the fit of a single product size on the population, or to evaluate which portion of a population will be provided with good fit using a group of articles spanning a range of sizes. By computationally evaluating fit and other product attributes using a population of avatars that are representative of an actual human cohort, product developers can more rapidly determine what adjustments are needed to improve fit or what size offerings may be needed to maximize the percentage of the population for which the product will fit well, while simultaneously minimizing the number of different product configurations that are required for a particular product and target population. For a particular example of a fit mapping technique developed for disposable diapers see, Pieper, et al., titled “Designing Diapers and Sizing Schemes with a Fit Mapping Tool, [date] [location], incorporated by reference herein in its entirety.

The product may include any article of clothing, and may also include personal care products worn by an individual. That is, the performance of products having some function beyond just covering a portion of the body such as disposable diapers, disposable pants, medical garments, feminine hygiene products, incontinence products, medical drapes, facemasks, barrier products, or moisturizing products worn by an individual, such as lotion filled gloves or condition monitoring wristbands or socks may be evaluated using a population of avatars. Of course, the preceding list is meant to be illustrative, and the performance of other articles of clothing or items worn on the body of an individual may be the subject of a virtual reality simulation.

In one embodiment, the computational techniques described in the '300 and '734 patents may be used to generate the virtual reality simulation used to evaluate the fit and performance of an article on the avatars included in a population of avatars. However, other computational techniques may be used. For example, computational simulations of fluid handling performance and other attributes can be conducted to assess factors such as leakage for the specified articles on the avatar population. In such a case, the avatars could represent a population of infants or toddlers having body dimensions modeled after real human children.

Additionally, an avatar representing a particular individual may be used to assist a product manufacturer (or retailer) in marketing products to that individual. In one embodiment, a consumer may have an avatar generated to represent him or her and be presented with a virtual reality simulation that simulates how a given product would fit or perform. For example, qualitative aspects of a product and the individual's avatar could be evaluated to predict whether a given article would fit the individual or whether a consumer product would function well for the individual. Additionally, an individual, family members, or other group may have their personal physical proportions and other data stored in a database used in association with one or more virtual avatars to allow virtual environments to display realistic avatars for evaluation of fit and performance of personal products or other customized products under consideration.

In one embodiment, an individual may have a selection of physical body characteristics stored on a token device. Thereafter, when shopping for clothes or other items worn on the body, the user may provide the smart card to download personal information and observe a virtual reality representation of how an article looks, importantly, how well a given article may fit or perform. Alternatively, body characteristics may be obtained by scanning a consumer using a scanning device, or a consumer may interact with a virtual reality kiosk to specify a collection of parameters to describe themselves. For example, a consumer could be scanned to generate a collection of data describing that individual's body geometry, which could then be used to computationally represent an article of clothing on an avatar having the attributes of that consumer.

Such a system may model the appearance of the article, but importantly, may also model comfort issues during a variety of motions such as, for example, modeling calculation of pressure points, skin strain or friction etc. For example, in the case of absorbent articles, the model could simulate the risk of leakage or other problems based on a fit evaluation of the article being worn by the avatar representation of the consumer. Thus, the simulation may allow the consumer to assess the fit or performance of an article as the avatar moves in various positions, or to determine a proper product type and size based on the consumer's avatar.

In one embodiment, a retailer may provide a virtual reality kiosk to present the consumer with a virtual reality simulation of that consumer's avatar interacting with a product being considered for purchase. Additionally, a consumer may provide additional information used to personalize a virtual reality simulation. Examples of personalizing virtual reality environments are disclosed in a related U.S. patent application having Ser. No. 11/618,764, titled: “Virtual Reality System Including Personalized Virtual Environments,” and having attorney docket No. KIMB/0008 filed on the same day herewith, which is herein incorporated by reference in its entirety.

Using an avatar to simulate the fit or performance of an article of clothing may be particularly useful for assessing the performance of a product on a population for which it is difficult to obtain “real” data. For example, it is difficult, if not impossible to obtain qualitative data for infants and young children. Similarly, disabled individuals may have difficulty trying on and fitting articles, thus, using a virtual avatar to evaluate product design, size, and/or configurations for these populations may be an effective means of making purchasing decisions. And for the product manufacturer, may reduce the number of different product configurations required for a population, without sacrificing product converge for that population. Additionally, by identifying an individual as being part of a given population, aspects of product sizing, product fit, and product performance peculiar to that population may be used to inform the consumer and help guide product selection and purchasing decisions.

The following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

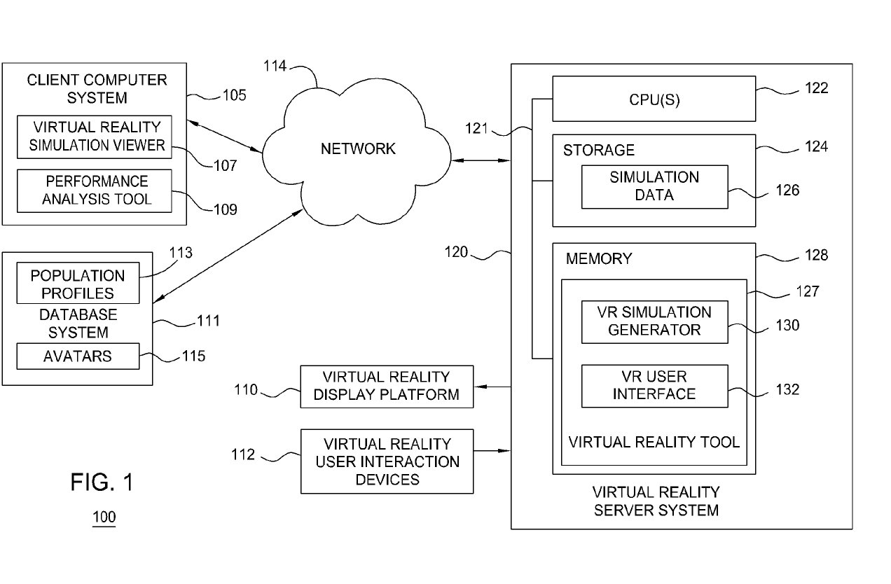

FIG. 1 is a conceptual diagram of a computing environment and virtual reality system, according to one embodiment of the invention. As shown, computing environment 100 includes a client computer system 105 and a database system 111 in communication with a virtual reality server system 120 over a network 114. The computer systems 105, 111, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustrations of computer systems 105, 111, and 120 are simplified to highlight aspects of the present invention and that computing systems and networks typically include a variety of components not shown in FIG. 1.

As shown, server system 120 includes one or more CPUs 122, storage 124, and memory 128 connected by a bus 121. CPU 122 is a programmable logic device that executes the instructions, logic and mathematical processing performed in executing user applications (e.g., a virtual reality tool 127). Storage 124 stores application programs and data for use by server system 120. Common storage devices 124 include hard-disk drives, flash memory devices, optical media and the like. Network 114 represents any kind of data communications network, including both wired and wireless networks. Accordingly, network 114 is representative of both local and wide area networks, including the Internet.

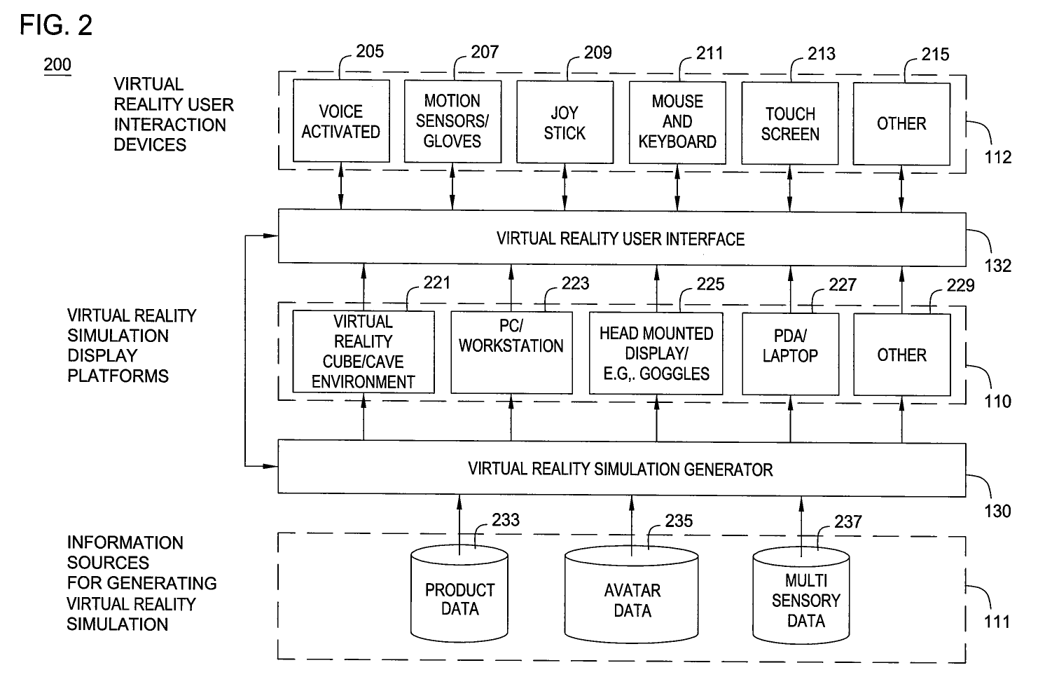

In one embodiment, virtual reality tool 127 may be configured to generate, present, and record a virtual reality simulation, such as a simulation of an avatar representation of a human body wearing an article of clothing or consumer care product. In one case, a product designer or market researcher may interact with a server system 120 using client computer system 105 and a viewing application 107 to create and review a virtual reality simulation. In one case, viewing application 107 may be a web-browser configured to display multi-media content such as audio and video streams. In another case, a consumer may be presented with a virtual reality simulation of a product being worn and/or used by the avatar using a variety of virtual reality user interaction devices 112. As shown, client computer system 105 also includes a performance analysis tool. In one embodiment, performance analysis tool 109 is a software application configured to analyze a virtual reality simulation of an article or product worn and/or used by an avatar, or population of avatars. Examples of display platforms 110 and user interaction devices 112 are described below in conjunction with the description of FIG. 2. Additionally, as is well-known, the processing activity of server system 120 may be coordinated by an operating system (not shown). Widely available operating systems include the Windows® operating system and distributions of the Linux® operating system, among others.

Database system 111 may be used to store a collection of information used by virtual reality tool 127 to generate a virtual realty simulation of a product being worn by an avatar 115, or a population of avatars 115. For example, database system 111 may store avatars 115 generated from a group of actual individuals selected to be representative of a population. Alternatively, avatars 115 may be generated according to a population profile 113 characterizing aspects of a target population. Population profiles 113 may be used to generate a population of avatars to represent a class of infants, children, or adults, of any ethnographic or demographic population cohort. More generally, database 111 may be used to store any data used by a virtual reality simulation generator 130 to generate a virtual reality simulation. In one embodiment, market researchers, product designers, retail sellers, etc., may generate and view simulations of the fit and performance of a product being worn by each member of a population of avatars. Product developers, marketers, and researchers can evaluate a broad variety of aspects of the product design, as well as aspects of product performance. Thus, embodiments of the invention may allow these individuals to readily identify opportunities and/or problems with product design, the sizing or coverage of a design, for the population of avatars.

In one embodiment, database system 111 and virtual reality server system 120 may be coupled to a virtual reality display platform 110 such as a virtual reality kiosk which may be used to present a simulation of the fit or performance of a given product being worn by a consumer, as represented by that consumer's avatar. Memory 128 of server system 120 includes virtual reality tool 127. Virtual reality tool 127 may be a software application that allows a virtual reality shopping simulation to be generated and presented to a user on virtual reality display platform 110. Such a simulation may be configured using simulation data 126 defining, among other things, an avatar and a product for the avatar to interact with. As shown, virtual reality tool 127 includes a simulation generator 130 and a user interface 132. User interface 132 provides an interface to configure and use virtual reality tool 127. Simulation generator 130 may be configured to generate the virtual reality environment from simulation data 126. In one embodiment, the virtual reality simulation may be presented to a market researcher, product designer, and/or product manufacturer. Alternatively, the virtual reality simulation may be presented to a simulation participant who interacts with the simulation while being observed and/or recorded by market researchers, product designers, product manufacturers, etc., for the purpose of performing market research.

FIG. 2 is a conceptual diagram further illustrating components of the virtual reality system first shown in FIG. 1, according to one embodiment of the invention. More specifically, FIG. 2 illustrates an exemplary collection of virtual reality display platforms 110, user interaction devices 112, and simulation data 126 used to generate and present virtual reality simulations of an avatar or population of avatars interacting with an article of clothing or personal care product. Interaction devices 112 may allow a simulation participant to interact with elements of the virtual reality simulation. As shown, input devices 112 may include a voice activated system 205, motion sensing devices 207 worn by a user, e.g., a set of motion sensing gloves or goggles, a joystick device 209, a mouse and keyboard device 211, a touch screen device 213, or other user interface device 215. Of course, depending on how a virtual reality simulation is presented to a simulation participant, the particular input devices 112 may be tailored to suit the needs in an individual case.

In various embodiments, different virtual reality display platforms may used to present a simulation participant or observer with a virtual reality simulation of an avatar interacting with a given product. As stated, by creating simulations for a population of avatars representative of a target population, the product design process may be enhanced. Similarly, generating a simulation that evaluates product “fit” or “performance” for an avatar representing a consumer may allow the consumer to make better purchasing decisions.

Illustratively, virtual reality display platforms include a virtual reality cube/sphere or “CAVE Automatic Virtual Environment” (CAVE) environment 221, a PC workstation 223 and LCD or CRT monitor, a head-mounted display 225 worn by a viewer or simulation participant, a PDA or laptop computer 227 or other virtual reality display platform 229. As is known, a CAVE environment provides immersive virtual environment where a user may interact with a virtual reality system inside a room where projectors are directed to, e.g., three, four, five or six of the walls of a cube. The images may be in stereo requiring stereo shutter glasses to be worn. Presenting a simulation participant with a simulation using virtual reality cube 221 may provide the participant with a fully immersive visualization where the screens of the CAVE/CUBE provide the participant's entire visual (and possibly other) sensory experiences). Similarly, a head mounted display 225, such as a virtual reality helmet or 3D goggles, may provide an immersive virtual environment for presenting a simulation of an avatar (or population of avatars) interacting with an article of clothing or personal care product.

In another embodiment, a virtual reality simulation may be displayed on a monitor of PC workstation 223 or on a display screen of a PDA or laptop 227. Of course, embodiments of the invention are not limited to these virtual reality display platforms, and may be adapted for use with other existing platforms as well as new ones that become available. As stated, virtual reality simulation generator 130 may be configured to generate a simulation presented on one or more of display platforms 110 based on specified simulation data 126. FIG. 2 illustrates a number of exemplary data sources that may be used to specify simulation data 126 for a given virtual reality simulation. As shown, simulation data may include product data 233, avatar data 235, and other data 237.

Product data 233 includes any data related to the product being evaluated and/or simulated in a virtual reality simulation. For example, product data 233 may include data related to product features, product appearance, materials, sizes, shapes, and the like. More specifically, product data 233 may be related to any aspects of a product such as product design, materials, aesthetics, ergonomic aspects, colors, shapes, scents, textures, sounds, user perceptions of usefulness and/or performance, price, branding, perceptions of value, package count, package design, purchase intent, sensory perceptions, among others. Similarly, avatar data 235 may include data related to the body shape, size, mass, volume, structure, position, movement, or other characteristics of an individual's body. Of course, the actual data may be tailored to suit the needs of a particular case. For example, in performing a simulation to evaluate a surgical cap, avatar data 235 could include a hat size, amount of heir, weight, the presence (or absence) of eyeglasses etc.

In addition to data 233 and 235, in one embodiment, a virtual reality simulation may be augmented using other data 237. For example, in addition to visual aspects of a virtual reality simulation, a multi-sensory simulation may be generated, including simulations of sights, sounds, tactile responses, or even tastes. Thus, a variety of aspects of the simulated product performance such as, sounds, smells, and actions resulting from a participants' interaction with the product may be included in a virtual reality simulation.

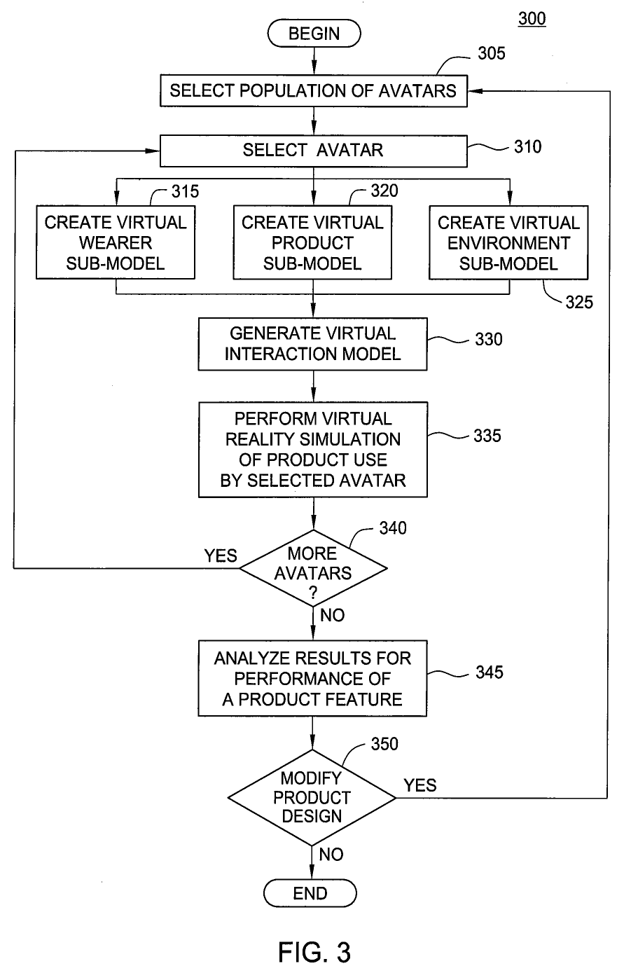

FIG. 3 is a flow diagram illustrating a method 300 for generating a virtual reality simulation for a population of avatars, according to one embodiment of the invention. Method 300 may be used to evaluate a product for use on a body, as represented by an avatar. Further, by generating simulations for a population of avatars, a product designer may tailor the number of product configurations required to serve a real-world target population of individuals. More specifically, method 300 may be used to help determine a preferred configuration for an article of clothing or consumer care product using a computer-based virtual product development and testing system, such as the virtual reality systems described above in conjunction with FIGS. 1-2. However, one of ordinary skill in the art will recognize that when used herein, examples of specific equipment, software, products, and wearers are for illustrative purposes, and other types of these items may be used without departing from the scope of the present invention.

As shown, the method 300 begins at step 305 where a population of avatars is selected. As described above, each avatar provides a representation of a human body, or part of a human body. And a population of avatars may be selected to be representative of a population of real humans such as a class of infants, children, or adults. In one embodiment, each avatar from the population of avatars, may be used in a virtual reality simulation configured to evaluate whether a given product configuration (e.g., the size and shape of an article of clothing or personal care product) will fit or perform well for members of the target population.

At step 310, an avatar from the population of avatars is selected to use in a virtual reality simulation to analyze product fit and/or performance. The selected avatar is then used in a virtual reality simulation where the avatar interacts with a given product. Accordingly, in one embodiment, method 300 includes creating a virtual wearer sub-model at step 315 and creating a virtual product sub-model at step 320. Additionally, an environment sub-model may also be generated at step 325 so that environmental factors affecting the product or the wearer may also be used in designing or evaluating the product. Information used to create the virtual wearer sub-model, virtual product sub-model, and the virtual environment sub-model may be obtained from product studies, databases, input from customers, or other sources of product, wearer or environmental data.

In one embodiment, numerical method analysis is used to transform the modeling solution of complex interaction between the wearer sub-model and the product sub-model into a system of algebraic equations. Any of the several methods of conducting numerical method analysis known to those skilled in the art may be used. Preferably, finite element analysis (FEA) is used, however, other methods such as finite difference scheme (FDS), boundary element method, minimax methods for parameterized forms, neural network schemes, or cellular automata can also be used. FEA simplifies the problem into a finite number of unknown fields, sub-divides the region to be analyzed into elements, and expresses each unknown field in terms of assumed approximating functions within each element. Each geometric sub-model is divided into small sections called finite elements through a process referred to as meshing, with a number of nodal points, or nodes, defined at intersections of adjacent elements in the mesh. Meshing is performed using conventional software. Constraints and material properties are then applied to each element of the meshed structure. For example, a user can select mechanical properties to simulate fabric, nonwovens, elastics, bone, muscle, body fat or tendon. As known to those skilled in the art, the types of analysis on the meshed model may include static linear analysis, dynamic non-linear analysis, stability analysis, fluid flow analysis, or heat transfer analysis. Additional examples of numerical analysis techniques appropriate for the virtual wearer sub-model, virtual product sub-model, and the virtual environment sub-model are disclosed in the '300 and '734 patents referenced above.

At step 330, once the sub-models are created at steps 315, 320, and 325 a virtual interaction model may be generated. In one embodiment, the product sub-model and the environment sub-model interact with one another according to the interaction model. The sub-models and the interaction defined by the interaction model are then combined to generate a reality simulation of product use by the selected avatar at step 335. That is, at step 335, a virtual reality simulation may be performed simulating the use of the virtual product sub-model (i.e., the product being evaluated) by the virtual wearer sub-model (i.e., the selected avatar). In one embodiment, the use model may calculate the forces, deformations and stresses caused by movement and interaction between the virtual wearer sub-model and the virtual product sub-model using FEA analysis to solve the solutions for the algebraic systems of equations using conventional FEA software to produce simulation results. These simulation results may be used to predict whether the product will “fit” or perform well for the individual represented by the avatar.

At step 340, the process of simulating the interaction of a product and a body may be repeated for additional avatars, from the population of avatars selected at step 305. Once the product use has been simulated for each avatar, at step 345, the results of the simulations are analyzed to evaluate the performance of body and/or product features embodied in the virtual wearer sub-model and virtual sub-model, such as when positioned on a virtual wearer and exposed to typical movements or forces. In one embodiment, the analysis evaluates the performance of at least one body and/or product feature of the product and/or wearer body.

At step 350, if additional testing is desired, the analyzed results can be used to redesign the virtual product by modifying the characteristics of one or more of the sub-models or the interaction model in order to modify the properties that affect the performance of the body and product features. That is, either, or both, of the avatar and product simulation may be modified. If so, after modifying one or more characteristics of the virtual sub-models or the interaction model, the modified models may be “worn” by members of the avatar population to obtain new simulation results. The results are again analyzed at step 345 to evaluate the new design.

A product designer may also perform the method 300 using multiple variations of sub-models having different parameters to perform a controlled set of experiments, or multiple variations of avatar populations. For example, sub-models can be created with high and low values for desired parameters and tested. The designer may then analyze the results of the multiple runs and based on expertise, statistical analysis, or other decision-making factors, select an ideal configuration for a product. For example, the results may be used to tailor a set of product sizes such that a size that fits well is available for each member of the population, and where the number of different product sizes is minimized. It is contemplated that the user may perform the method 300 using any combination of sub-models or avatar populations, for example, creating several product sub-models for use with a wearer sub-model or several environmental sub-models for use with a wearer sub-model.

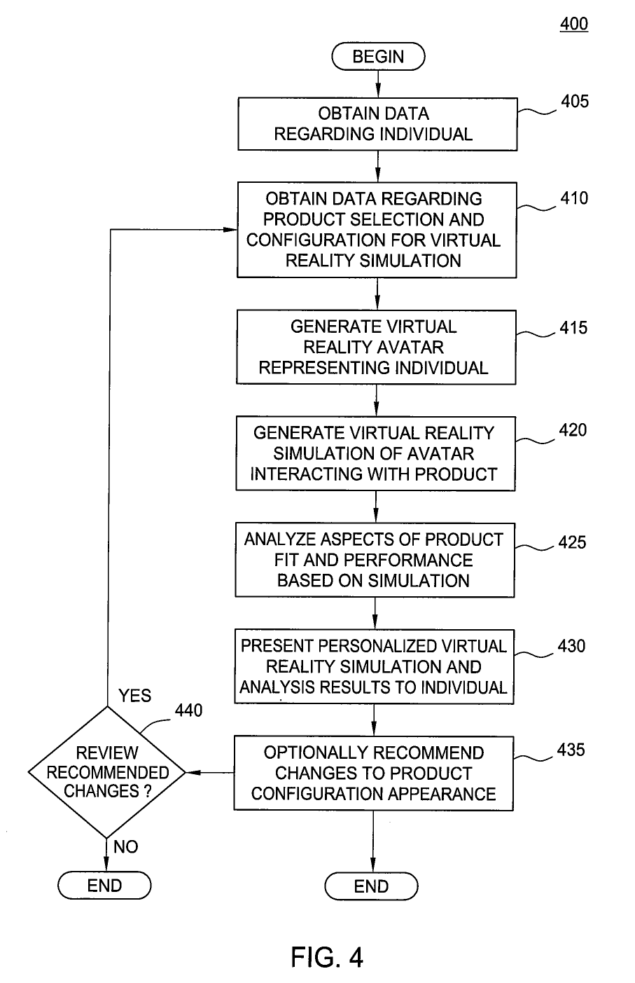

FIG. 4 is a flow diagram illustrating a method for assisting a consumer purchasing decision using virtual reality simulation that includes an avatar representation of the individual, according to one embodiment of the invention. As shown, the method 400 begins at step 405 where data regarding an individual is obtained. For example, an individual consumer may have a selection of physical body characteristics stored on a token device. Alternatively, body characteristics may be obtained by scanning a consumer using a scanning device, or a consumer may interact with a virtual reality kiosk to specify a collection of parameters to describe themselves.

At step 410, data regarding product selection and configuration for a virtual reality simulation is obtained. For example, as described above a consumer may select to evaluate a given article of clothing or personal care product. At step 415, an avatar representation of the consumer is generated. The characteristics of the avatar may be based on the data obtained at step 415.

At step 420, using the avatar generated at step 415, and the product data specified at step 410, a virtual reality simulation of the avatar interacting with the selected product is generated and performed. That is, the interaction between the avatar representation of the consumer and the product is simulated. For example, as described above, a virtual wearer sub-model and a virtual product sub-model may be generated to interact with product use and interaction models. At step 425, the results of the simulation are analyzed to predict the fit and performance of the product, and the results are presented to the user at step 430. In one embodiment, the consumer may be presented with a display representation of the article of clothing on an individual. Fit and performance characteristics may also be indicated. For example, the display may use colors to indicate a location where an absorbent product may fail, or where the product may not fit the consumer well (e.g., an area where the article of clothing may be constricting or otherwise uncomfortable when worn by the consumer).

Additionally, at step 435, the consumer may be presented with recommendations of changes to the product configurations or alternate products, which might have superior fit or performance characteristics for that consumer. For example, if the simulation generated at step 420 and analyzed at step 425 determines that the consumer has selected a personal care product that is too small (which would be unconformable) or too large (which may be prone to leak) based on the avatar representation of the individual, then alternatives sizes, products, or product configurations may be recommended. In such a case, at step 440, the consumer may select to review a simulation of the recommended changes, and the method 400 may return to step 410 and generate a simulation of the modified product interacting with the avatar representation of the individual.

While the foregoing is directed to embodiments of the present invention, other and further embodiments of the invention may be devised without departing from the basic scope thereof, and the scope thereof is determined by the claims that follow.

What is claimed is:

1. A computer-assisted method of designing a product to be worn by an individual, comprising:
selecting a population of avatars, wherein each avatar provides a representation of at least a portion of a human body, and wherein the population of avatars is representative of a population of individuals;
obtaining a set of data describing a product to be worn by the individuals in the population of individuals; and
for each avatar, in the population avatars:
generating a virtual reality simulation that simulates an avatar interacting with the product, and
analyzing the interaction between the avatar and the selected product to evaluate at least one performance characteristic of the product.

2. The method of claim 1, wherein the product to be worn by the individual is a personal care product.

3. The method of claim 2, wherein the performance characteristic of the product provides an indication of whether the personal care product fits the portion of a human body represented by the avatar.

4. The method of claim 1, wherein the population of individuals represents at least one of a class of infants, children, and adults.

5. The method of claim 1, wherein the population of individuals represents ethnographic or demographic population of individuals.

6. The method of claim 1, wherein generating a virtual reality simulation that simulates an avatar interacting with the product comprises:
creating a computer based virtual wearer sub-model of at least a portion of the body on which the product is to be positioned;
creating a computer based product sub-model of the product;
defining an environment in which the body sub-model interacts with the product sub-model with an environment sub-model;
interacting the body sub-model, the product sub-model, and the environment sub-model with an interaction model, wherein the interaction model describes a set of actions simulating the product sub-model being worn by body sub-model; and
combining the body sub-model, the product sub-model, the environment sub-model and the interaction model in a virtual reality simulation simulating the interaction between the body sub-model, the product sub-model and the environment sub-model.

7. The method of claim 6, wherein the step of analyzing the interaction between the avatar and the selected product to evaluate at least one performance characteristic of the product comprises:
evaluating the virtual reality simulation to determine the performance characteristic of the product; and
modifying the product sub-model in response to the performance of the product characteristic and reperforming the steps of interacting and combining the models and the step of evaluating the virtual reality simulation to determine performance of the performance characteristic for the modified product sub-model.

8. A computer-readable storage medium containing a program configured to generate a virtual reality simulation used to facilitate market research, the program including instructions for performing an operation, comprising:
selecting a population of avatars, wherein each avatar provides a representation of at least a portion of a human body, and wherein the population of avatars is representative of a population of individuals;
obtaining a set of data describing a product to be worn by the individuals in the population of individuals; and
for each avatar, in the population avatars:
generating a virtual reality simulation that simulates an avatar interacting with the product, and
analyzing the interaction between the avatar and the selected product to evaluate at least one performance characteristic of the product.

9. The computer-readable storage medium of claim 8, wherein the product to be worn by the individual is a personal care product.

10. The computer-readable storage medium of claim 9, wherein the performance characteristic of the product provides an indication of whether the personal care product fits the portion of a human body represented by the avatar.

11. The computer-readable storage medium of claim 8, wherein the population of individuals represents at least one of a class of infants, children, and adults.

12. The computer-readable storage medium of claim 8, wherein the population of individuals represents ethnographic or demographic population of individuals.

13. The computer-readable storage medium of claim 8, wherein generating a virtual reality simulation that simulates an avatar interacting with the product comprises:
creating a computer based virtual wearer sub-model of at least a portion of the body on which the product is to be positioned;
creating a computer based product sub-model of the product;
defining an environment in which the body sub-model interacts with the product sub-model with an environment sub-model;
interacting the body sub-model, the product sub-model, and the environment sub-model with an interaction model, wherein the interaction model describes a set of actions simulating the product sub-model being worn by body sub-model; and
combining the body sub-model, the product sub-model, the environment sub-model and the interaction model in a virtual reality simulation simulating the interaction between the body sub-model, the product sub-model and the environment sub-model.

14. The computer-readable storage medium of claim 13, wherein the step of analyzing the interaction between the avatar and the selected product to evaluate at least one performance characteristic of the product comprises:
evaluating the virtual reality simulation to determine the performance characteristic of the product; and
modifying the product sub-model in response to the performance of the product characteristic and reperforming the steps of interacting and combining the models and the step of evaluating the virtual reality simulation to determine performance of the performance characteristic for the modified product sub-model.

15. A computer-implemented method for assisting a consumer purchasing decision, comprising:
obtaining a first set of data describing at least one physical characteristic of an individual;
generating an computer-based avatar, wherein the avatar provides a representation of at least a portion the body of the individual;
obtaining a set of data describing a product to be worn by the individual;
generating a virtual reality simulation that simulates the avatar interacting with the product;
analyzing the interaction between the avatar and the selected product to evaluate at least one performance characteristic of the product; and
presenting the individual with the results of the virtual reality simulation.

16. The method of claim 15, wherein the product to be worn by the individual is a personal care product.

17. The method of claim 16, wherein the performance characteristic of the product provides an indication of whether the personal care product fits the portion of a human body represented by the avatar.

18. The method of claim 15, wherein presenting the individual with the results of the virtual reality simulation comprises providing a visual display of the avatar representation of the individual wearing the product.

19. A computer-readable storage medium containing a program configured to generate a virtual reality simulation for assisting a consumer purchasing decision, the program including instructions for performing an operation, the operation comprising:
obtaining a first set of data describing at least one physical characteristic of an individual;
generating an computer-based avatar, wherein the avatar provides a representation of at least a portion the body of the individual;
obtaining a set of data describing a product to be worn by the individual;
generating the virtual reality simulation that simulates the avatar interacting with the product;
analyzing the interaction between the avatar and the selected product to evaluate at least one performance characteristic of the product; and
presenting the individual with the results of the virtual reality simulation.

20. The computer-readable storage medium of claim 19, wherein the product to be worn by the individual is a personal care product.

21. The computer-readable storage medium of claim 19, wherein the performance characteristic of the product provides an indication of whether the personal care product fits the portion of a human body represented by the avatar.

22. The computer-readable storage medium of claim 21, wherein presenting the individual with the results of the virtual reality simulation comprises providing a visual display of the avatar representation of the individual wearing the product.
